(19) United States
(12) Patent Application Publication
(10) Pub. No.: US 2020/0072973 A1
(43) Pub. Date: Mar. 5, 2020

(54) METHOD FOR OPERATING AN ULTRASONIC SENSOR

(71) Applicant: Robert Bosch GmbH, Stuttgart (DE)

(72) Inventors: Dirk Schmid, Simmozheim (DE); Michael Schumann, Stuttgart (DE)

(21) Appl. No.: 16/468,160

(22) PCT Filed: Nov. 8, 2017
(86) PCT No.: PCT/EP2017/078553

§ 371 Date: Jun. 10, 2019

(30) Foreign Application Priority Data
Dec. 14, 2016 (DE) 10 2016 224 932.0

(51) Int. Cl. G01S 15/10; G01S 7/527; G01S 15/32; G01S 15/93

(52) U.S. Cl. CPC G01S 15/101; G01S 7/527; G01S 15/931; G01S 15/104; G01S 15/32

(57) ABSTRACT

A method for operating an ultrasonic sensor is provided, a plurality of measuring cycles being consecutively carried out. In each measuring cycle, an electroacoustic transducer of the ultrasonic sensor is excited to carry out mechanical oscillations with the aid of an excitation pulse, whereby a measuring signal is transmitted by the transducer, an echo signal is received by the transducer, and a piece of object information is ascertained from the echo signal. The frequency profile of the excitation pulse differs in measuring cycles which are carried out chronologically consecutively, the frequency profile of an excitation pulse being selected in each measuring cycle randomly or according to a predefined sequence from a group of predefined frequency profiles.

### FIELD

The present invention relates to a method for operating an ultrasonic sensor as well as to a distance measuring device including at least one ultrasonic sensor which is operated according to the method according to the present invention.

### BACKGROUND INFORMATION

Ultrasound-based measuring systems are used to measure a distance from an object located ahead of an ultrasonic sensor. The used sensors are generally based on the pulse-echo method. During this operation, an ultrasonic sensor transmits an ultrasonic pulse and measures the reflection of the ultrasonic pulse (echo) caused by an object. The distance between the ultrasonic sensor and the object is computed via the measured echo travel time and the speed of sound. In this case, the ultrasonic sensor is used as a transceiver. Known applications are, for example, distance warning systems, parking space detectors, and parking assist systems for motor vehicles. In a measuring system of this type, multiple ultrasonic sensors are usually used.

In the case of conventional distance measuring devices on vehicles, 4 to 6 ultrasonic sensors are typically used in the front and/or rear bumper(s). In order to detect the surroundings preferably rapidly, it is helpful if all ultrasonic sensors on the bumper(s) simultaneously transmit information, so that this information may be processed in parallel. For this purpose, it is possible to select for each ultrasonic sensor special excitation patterns, so-called codes for transmitting, which are different from one another.

German Patent Application No. DE 10 2007 029 959 A1 provides an ultrasound-based measuring system for detecting its surroundings. It is provided in this case that distance measurements may be carried out with the aid of ultrasonic waves. In order to be able to differentiate between two consecutive pulses, they are frequency modulated.

German Patent Application No. DE 10 2013 021 845 A1, in turn, provides a method for measuring a distance with the aid of ultrasound. It is provided in this case that individual ultrasonic signals are coded for the purpose of differentiability.

The processing of the signals in the reception path may, for example, take place by filtering the received signals through a signal-adapted filter (so-called “matched filter”).

So-called “ideal codes” are usually used for the excitation. “Ideal codes” are characterized in that the codes are orthogonal to one another, i.e. the matched filters of the codes act in such a way that they suppress the external codes to the greatest extent. In practice, however, it is hardly possible to completely suppress these foreign codes through matched filters.

Now, if an ultrasonic sensor of the distance measuring device is assigned a certain code, the interference is at its maximum—in the case of another vehicle using the same coding—if the ultrasonic sensors involved are located opposite one another.

### SUMMARY

An object of the present invention is to provide a method for operating an ultrasonic sensor in which the effect of interferences, which may be caused, in particular, by the ultrasonic signals of other vehicles, is reduced.

The present invention is based on the idea of coding signals which are transmitted by an ultrasonic sensor operated according to the present invention. The coding takes place either with the aid of randomly selected codes or with the aid of randomly selected code sequences. In addition, a transmitting point in time of an ultrasonic signal may be preferably stochastically jittered. It may be ensured in this way that interfering effects from adjacent ultrasonic systems, such as in particular in the case of two vehicles converging, are largely avoided. Here, it is provided according to the present invention to change the codes after every measuring cycle. A measuring cycle refers to a complete run-through up until the rerun of the transmit mode of the same sensor.

Therefore, a method for operating an ultrasonic sensor is provided, a plurality of measuring cycles being consecutively carried out. In each measuring cycle
an electroacoustic transducer of the ultrasonic sensor is excited with the aid of an excitation pulse to carry out mechanical oscillations, whereby a measuring signal is transmitted by the transducer,
an echo signal is received by the transducer, and
a piece of object information is ascertained from the echo signal.

According to the present invention, the frequency profile of the excitation pulse differs in measuring cycles which are carried out chronologically consecutively, the frequency profile of an excitation pulse being selected in each measuring cycle randomly or according to a predefined sequence from a group of predefined frequency profiles.

In other words, it is therefore provided according to the present invention to operate an ultrasonic sensor for measuring a distance using a special code. Each code corresponds to a certain excitation pattern, it being provided that following each excitation, a different excitation pattern, i.e., a different code, is used for a chronologically consecutive, repeated excitation. According to a first variant of the present invention, a code may be randomly selected in each measuring cycle from a predefined group of codes. According to a second variant, the sequence according to which the codes are selected from the predefined group of codes is fixedly predefined.

The ascertained object information from at least two measuring cycles is preferably compared to one another and an interference is detected as a function of the result of the comparison. An interference is in this case in particular understood to mean an erroneous measurement which may be caused by an ultrasonic signal of an external ultrasonic sensor which is, for example, a part of a distance measuring system of another vehicle.

The transmitting point in time is preferably stochastically jittered within a particular measuring cycle transmitting point in time. This means that the point in time at which the particular excitation pulse is applied to the transducer, is shifted by a randomly selected time period in relation to a starting point in time of the measuring cycle. This time duration is in particular short when compared to the total duration of the particular measuring cycle and may range from 1 ms to 10 ms, for example, the total duration of the measuring cycle being approximately 40 ms, for example. This implementation is particularly advantageous in the second variant of the present invention, since even though the probability of synchronization is reduced in the second variant, interferences are still always possible in the case of the deterministic sequence of selected excitation patterns (codes). This effect may be further minimized by stochastically jittering the transmitting point in time. Jittering is also advantageous for the first variant.

It is furthermore advantageous if the excitation patterns (codes) of the group, from which the particular code is selected, are designed in such a way that they maximally suppress each other. This is achieved, for example, in that the codes of the group are orthogonal to one another.

In one preferred embodiment, the duration of a first excitation pulse of a first measuring cycle differs from the duration of a second excitation pulse of a second measuring cycle, the second measuring cycle chronologically following the first measuring cycle. In this case, the second measuring cycle may directly follow the first measuring cycle. This means that no further signal is transmitted between the first and the second measuring cycle, there may, however, be a pause between the first and the second measuring cycle in which there is no excitation. Alternatively, the second measuring cycle cannot directly follow the first measuring cycle, but a further excitation may take place between the first and the second measuring cycle.

Alternatively or additionally, the amplitude of a first excitation pulse of a first measuring cycle may differ from the amplitude of a second excitation pulse of a second measuring cycle. This results in the sound pressure of the particular transmitted signals being different. In this case, the second measuring cycle may directly follow the first measuring cycle. This means that no further signal is transmitted between the first and the second measuring cycle; there may, however, be a pause between the first and the second measuring cycle in which there is no excitation. Alternatively, the second measuring cycle cannot directly follow the first measuring cycle, but an excitation may take place between the first and the second measuring cycle.

The excitation pulses are preferably carried out as frequency modulated pulses. In the sense of the present invention, a frequency modulated excitation pulse is to be understood to mean every excitation pulse whose frequency changes in the course of the pulse duration. Continuous and/or discontinuous changes in the frequency may be provided in this case. Alternatively or additionally, pulses having continuously constant excitation frequencies may also be used.

In one preferred embodiment of the present invention, the particular excitation pulses are modulated through an, in particular linear, frequency profile, in particular in a frequency range between 40 kHz and 60 kHz. This means that, starting from a starting frequency, the frequency of the particular excitation pulse rises or declines continuously and in particular linearly until an end frequency is reached. An excitation of this type is also referred to as a “chirp.” In this case, the starting frequency and the end frequency are preferably selected from the frequency range of 40 kHz to 60 kHz.

In one particularly preferred embodiment of the present invention, the received echo signals are filtered with the aid of a matched filter (also referred to as an optimal filter or a correlation filter). This may advantageously improve the signal-to-noise ratio by using the known signal form of the excitation pulse in a conventional manner when choosing the filter. A piece of object information is ascertained at a higher accuracy as a function of the filtering result.

In one particularly preferred embodiment of the present invention, a probability that a detected object is indeed present or that the measurement is erroneous is computed as a function of the result of the comparison of the object information from at least two measuring cycles. This makes it possible to particularly efficiently suppress interferences through ultrasonic signals of other vehicles in the sense of erroneous measurements (“false positives”).

In one preferred embodiment of the present invention, at least four measuring cycles are provided during the operation of the ultrasonic sensor, the transducer of the ultrasonic sensor being controlled in each measuring cycle with the aid of an excitation pulse having a different excitation pattern or frequency profile; in each measuring cycle, either an excitation pattern is selected randomly from a group of possible excitation patterns or an excitation pattern is selected from the group according to a predefined sequence.

According to a second aspect of the present invention, a distance measuring device, in particular for a motor vehicle, is provided which includes at least one ultrasonic sensor which is operated according to one of the methods described above.

A distance measuring device is in particular provided which includes a plurality of ultrasonic sensors operated according to one of the methods which are carried out as described above, the ultrasonic sensors being situated in a line at a chassis part of a motor vehicle. In this case, the ultrasonic sensors are operated in such a way that the ultrasonic sensors which are situated adjacently to one another do not have chronologically overlapping measuring cycles.

### BRIEF DESCRIPTION OF THE DRAWINGS

FIG. 1 schematically shows a distance measuring device including a plurality of ultrasonic sensors according to one embodiment of the present invention.

FIG. 2 shows four diagrams of possible frequency profiles for the excitation pulses.

FIG. 3 shows a table having a sequence of measuring cycles for different ultrasonic sensors of a distance measuring device including a plurality of ultrasonic sensors according to one embodiment of the present invention.

### DETAILED DESCRIPTION OF EXAMPLE EMBODIMENTS

In the following description of the exemplary embodiments of the present invention, identical elements are denoted by the same reference numerals; a repetitive description of these elements is dispensed with. The figures represent the subject matter of the present invention only schematically.

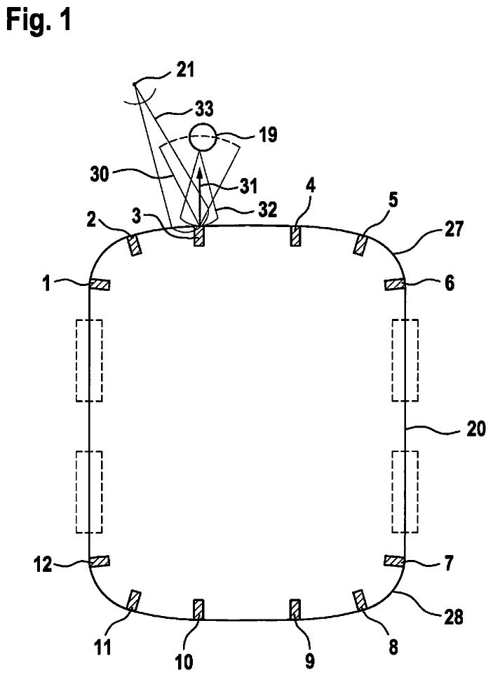

FIG. 1 schematically shows in a top view a motor vehicle 20 including a front bumper 27 on which ultrasonic sensors 1 through 6 are situated in a line and a rear bumper 28 on which ultrasonic sensors 7 through 12 are situated in a line. Ultrasonic sensors 1 through 12 are part of a distance measuring device for detecting the surroundings of motor vehicle 20. Furthermore, an object 19 to be detected with the aid of the ultrasonic sensors is illustrated in the surroundings of motor vehicle 20. Object 19 may, for example, involve a traffic obstruction, such as a flower tub, a traffic sign, or a street lamp as well as another vehicle.

Each of ultrasonic sensors 1 through 12 includes an electroacoustic transducer which is excited by a frequency modulated excitation pulse to carry out mechanical oscillations, whereby a measuring signal 30 is transmitted by the transducer. The present invention is not limited to the ultrasonic sensors being situated at the rear end or at the front end of a motor vehicle 20. Alternatively or additionally, further ultrasonic sensors may be situated, for example in the area of the sides, in particular of the doors, of motor vehicle 20.

In conjunction with ultrasonic sensor 3, a transmitting cone of a transmitted measuring signal 30 as well as a directional arrow 31, which indicates the transmitting direction, is illustrated by way of example. It is apparent that the transmitting cone hits object 19, so that measuring signal 30 is partially reflected from object 19 in the direction toward ultrasonic sensor 3 in a second transmitting cone (echo) 32.

Ultrasonic sensor 3 registers reflection 32 and the time which elapsed overall between the transmission of the transmitted pulse and the reception of the reflection is determined. The elapsed time is used to compute the distance of object 19 from ultrasonic sensor 3, when the signal speed is known, for example the speed of sound in the air of approximately 343 m/s.

The same measuring principle applies to the other ultrasonic sensors.

Now, ultrasonic sensor 3 is not only able to receive measuring signals 32 which are reflected from object 19, but also ultrasonic signals 33 which are emitted by a different sound source 21, for example by another vehicle. This may result in erroneous measuring results or objects being detected by the distance measuring system, even though in reality, there is no object present (“false positive”).

In order to address these problems, ultrasonic sensor 3 is operated in such a way that several measuring cycles are carried out consecutively. In each measuring cycle, a different excitation pulse is used to excite the electroacoustic transducer than was used in the preceding measuring cycle, the particular frequency profile of the excitation pulses being different in the measuring cycles which are carried out chronologically consecutively. In this case, the frequency profile of an excitation pulse is selected in each measuring cycle randomly or according to a predefined sequence from a group of predefined frequency profiles.

Frequency modulated excitation pulses (codes) are in particular selected as those excitation patterns which are designed as so-called “linear FM chirps.” This means that the excitation frequency linearly changes during the excitation pulse from a starting frequency to a target frequency. The present invention is, however, not limited to this type of frequency modulation; other excitation patterns are also possible, such as rising and then declining frequencies during an excitation pulse. Furthermore, at least sectionally constant frequency profiles may also be used, for example. Those skilled in the art are aware of various other possible implementations related hereto.

According to one preferred embodiment of the present invention, it is now provided for each of ultrasonic sensors 1 through 12 to vary the excitation patterns (codes) on a shot-to-shot basis in such a way that the particular frequency profile of the excitation pulses differs in measuring cycles which are carried out chronologically consecutively, the frequency profile of an excitation pulse being selected in each measuring cycle randomly or according to a predefined sequence from a group of predefined frequency profiles.

Exemplary excitation patterns for the frequency modulated excitation pulses are shown in the figure in diagrams 41 through 44. In this case, the frequency is plotted against time in each case. These excitation patterns preferably form a group from which one excitation pattern is selected in each measuring cycle as the excitation pulse for the transducer of an ultrasonic sensor 1 through 12. The selecting process may either take place randomly or according to a predetermined sequence. Frequency f₀ is 48 kHz in this example, pulse duration T is 1.6 ms.

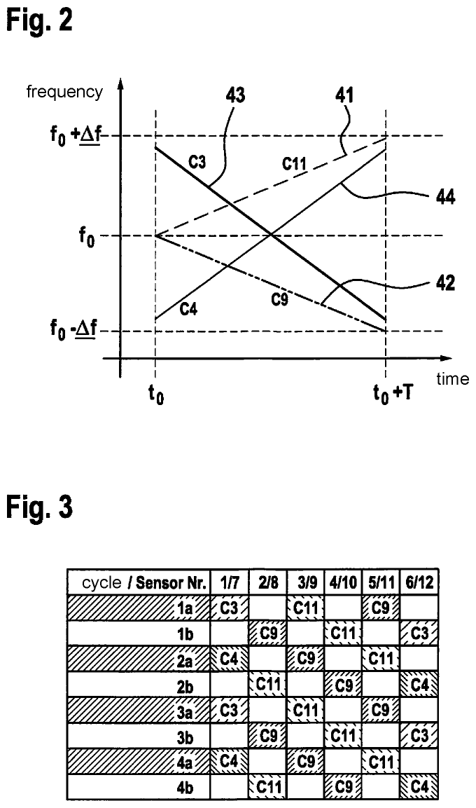

In the exemplary embodiment illustrated in FIG. 2, it is provided that the group of possible excitation patterns includes the following excitation patterns (codes):
a linear chirp 41 is carried out from a starting frequency f₀=48.5 kHz to an end frequency f₀+Δf=53.5 kHz at a duration of 1.6 ms (=1600 μs). This form of an excitation pulse is denoted in the following with symbol C11.
a linear chirp 42 is carried out from the starting frequency f₀=48 kHz to end frequency f₀−Δf=43 kHz at a duration of 1.6 ms (=1600 μs). This form of an excitation pulse is denoted in the following with symbol C9.
a linear chirp 43 is carried out from the starting frequency of 54 kHz to the end frequency of 45 kHz at a duration of 1.6 ms (=1600 μs). This form of an excitation pulse is denoted in the following with symbol C3.
a linear chirp 44 is carried out from the starting frequency of 43.5 kHz to the end frequency of 52.5 kHz at a duration of 1.6 ms (=1600 μs). This form of an excitation pulse is denoted in the following with symbol C4.

These excitation patterns may now be carried out in each of the ultrasonic sensors in a determined or random sequence, chronologically consecutive measuring cycles preferably differing from one another in one ultrasonic sensor in terms of their particular excitation patterns.

Preferably, starting point in time t₀ of an excitation by one of excitation pulses C9, C11, C3, or C4 may be additionally jittered.

It is to be pointed out that the illustration of the excitation patterns according to FIG. 2 is to be understood to be schematic and not true to scale.

One possible example of the chronological sequence of the control of ultrasonic sensors 1 through 12 is illustrated tabularly in FIG. 3. Here, the rows of the table refer to the time intervals which are available for a measuring cycle. In such a time interval, the excitation of the electroacoustic transducer as well as the reception of reflected ultrasonic signals and the ascertainment of a piece of object information take place. These time intervals may each have the same length, differing lengths may, however, also be provided.

The columns of the table refer in each case to a pair of ultrasonic sensors 1 and 7, 2 and 8, 3 and 9, 4 and 10, 5 and 11, and 6 and 12 which are situated at the front end and at the rear end and which are each controlled simultaneously with the aid of the same excitation pattern in this example.

This means that in this example, ultrasonic sensor 1 and ultrasonic sensor 7 are controlled with the aid of an excitation pulse of form C3 at the beginning of the operation of the distance measuring device in a first time interval 1a according to their first measuring cycles; this means that the particular electroacoustic transducer of ultrasonic sensors 1 and 7 is acted on by a corresponding excitation pulse and transmits a corresponding measuring signal in each case. Ultrasonic sensors 3 and 9 are simultaneously controlled with the aid of an excitation pulse of form C11. Ultrasonic sensors 5 and 11 are also simultaneously controlled with the aid of an excitation pulse of form C9.

Chronologically following the first time interval, ultrasonic sensor pair 2/8 is controlled in a second time interval 1b with the aid of an excitation pulse of form C9. Ultrasonic sensor pair 4/10 is simultaneously controlled with the aid of an excitation pulse of form C11. Ultrasonic sensor pair 6/12 is also simultaneously controlled with the aid of an excitation pulse of form C3.

In a chronologically following third time interval 2a, ultrasonic sensor pair 1/7 is controlled with the aid of an excitation pulse of form C4. Ultrasonic sensor pair 3/9 is simultaneously controlled with the aid of an excitation pulse of form C9. Ultrasonic sensor pair 5/11 is also simultaneously controlled with the aid of an excitation pulse of form C11.

In a chronologically following fourth time interval 2b, ultrasonic sensor pair 2/8 is controlled with the aid of an excitation pulse of form C11. Ultrasonic sensor pair 4/10 is simultaneously controlled with the aid of an excitation pulse of form C9. Ultrasonic sensor pair 6/12 is also simultaneously controlled with the aid of an excitation pulse of form C4.

In a chronologically following fifth time interval 3a, ultrasonic sensor pair 1/7 is controlled with the aid of an excitation pulse of form C3. Ultrasonic sensor pair 3/9 is simultaneously controlled with the aid of an excitation pulse of form C11. Ultrasonic sensor pair 5/11 is also simultaneously controlled with the aid of an excitation pulse of form C9.

In a chronologically following sixth time interval 3b, ultrasonic sensor pair 2/8 is controlled with the aid of an excitation pulse of form C9. Ultrasonic sensor pair 4/10 is simultaneously controlled with the aid of an excitation pulse of form C11. Ultrasonic sensor pair 6/12 is also simultaneously controlled with the aid of an excitation pulse of form C3.

In a chronologically following seventh time interval 4a, ultrasonic sensor pair 1/7 is controlled with the aid of an excitation pulse of form C4. Ultrasonic sensor pair 3/9 is simultaneously controlled with the aid of an excitation pulse of form C9. Ultrasonic sensor pair 5/11 is also simultaneously controlled with the aid of an excitation pulse of form C11.

In a chronologically following eighth time interval 4b, ultrasonic sensor pair 2/8 is controlled with the aid of an excitation pulse of form C11. Ultrasonic sensor pair 4/10 is simultaneously controlled with the aid of an excitation pulse of form C9. Ultrasonic sensor pair 6/12 is also simultaneously controlled with the aid of an excitation pulse of form C4.

When contemplating one individual ultrasonic sensor or one ultrasonic sensor pair, it becomes apparent from the table in FIG. 3 that each ultrasonic sensor or each ultrasonic sensor pair, contemplated by itself, changes its excitation pattern on a shot-to-shot basis (i.e., in chronologically consecutive measuring cycles of the particular sensor or sensor pair). Ultrasonic sensor 1 is, for example, used to carry out a measurement in the first time interval. The first time interval thus corresponds to the first measuring cycle of ultrasonic sensor 1. In this first measuring cycle, the electroacoustic transducer of ultrasonic sensor 1 is excited to carry out mechanical oscillations with the aid of a frequency modulated excitation pulse having form C3. Following the termination of the measuring cycle, ultrasonic sensor 1 remains passive until the second measuring cycle of ultrasonic sensor 1 is carried out in the third time interval. In this second measuring cycle, the electroacoustic transducer of ultrasonic sensor 1 is excited to carry out mechanical oscillations with the aid of a frequency modulated excitation pulse having form C4. The third measuring cycle of ultrasonic sensor 1 takes place in the fifth time interval. The fourth measuring cycle of ultrasonic sensor 1 takes place in the seventh time interval. The frequency profile of the frequency modulated excitation pulse thus differs in each measuring cycle. The same also applies to all other ultrasound sensors 2 through 6.

It also becomes apparent that adjacently situated sensors are not operated simultaneously.

Following the transmission of measuring signals 30 by one of ultrasonic sensors 1 through 12, particular ultrasonic sensor 1 through 12 may receive a reflected ultrasonic signal 32. By appropriate filtering of the received signals, which is in particular adapted to the frequency profile of the excitation pulse in the form of a matched filter, it is possible to distinguish actual echo signals from external signals 33 in that the external signals are suppressed by the filter. With the aid of the embodiment according to the present invention in which the particular frequency profile of the excitation pulses differs in measuring cycles which are carried out chronologically consecutively, the frequency profile of an excitation pulse being selected in each measuring cycle randomly or according to a predefined sequence from a group of predefined frequency profiles, it is ensured that even in the case of identically designed distance measuring systems in other vehicles, there is only a slight chance that external signal 33 has the exact same frequency profile as one's own measuring signal 30.

1-13. (canceled)

14. A method for operating an ultrasonic sensor, the method comprising:
consecutively carrying out a plurality of measuring cycles, in each of the measuring cycles:
exciting an electroacoustic transducer of the ultrasonic sensor via an excitation pulse to carry out mechanical oscillations, whereby a measuring signal is transmitted by the transducer;
receiving an echo signal the transducer; and
ascertaining a piece of object information from the echo signal;
wherein a frequency profile of the excitation pulse being different in two measuring cycles which are carried out chronologically consecutively;
wherein the frequency profile of the excitation pulse is selected in each measuring cycle randomly or according to a predefined sequence from a group of predefined frequency profiles.

15. The method as recited in claim 14, wherein the object information from at least two measuring cycles is compared to one another and an interference is detected as a function of a result of the comparison.

16. The method as recited in claim 14, wherein the excitation pulses have a total duration from 100 μs to 3000 μs.

17. The method as recited in claim 14, wherein the excitation pulses have a total duration of 1600 μs.

18. The method as recited in claim 14, wherein a duration of a first excitation pulse of a first measuring cycle of the measuring cycles differs from a duration of a second excitation pulse of a second measuring cycle of the measuring cycles.

19. The method as recited in claim 14, wherein an amplitude of a first excitation pulse of a first measuring cycle of the measuring cycles differs from an amplitude of a second excitation pulse of a second measuring cycle of the measuring cycles.

20. The method as recited in claim 14, wherein at least one excitation pulse is carried out as a frequency modulated excitation pulse.

21. The method as recited in claim 20, wherein at least one excitation pulse is modulated, by a linear frequency profile, between a starting frequency and an end frequency, the starting frequency and the end frequency being selected from a frequency range between 40 kHz and 60 kHz.

22. The method as recited in claim 14, wherein the echo signals are filtered using a matched filter and a piece of object information is ascertained as a function of a filtering result of the filtering.

23. The method as recited in claim 14, wherein a probability that a detected object is indeed present or that the measurement is erroneous is computed as a function of a result of a comparison of the object information from at least two measuring cycles of the measuring cycles.

24. The method as recited in claim 14, wherein the measuring cycles include at least two measuring cycles.

25. The method as recited in claim 24, wherein the measuring cycles include at least four measuring cycles are provided.

26. A distance measuring device for a motor vehicle, comprising:
at least one ultrasonic sensor, the at least one ultrasonic sensor being operated by:
consecutively carrying out a plurality of measuring cycles, in each of the measuring cycles:
exciting the consecutively carrying out a plurality of measuring cycles, in each of the measuring cycles:
exciting an electroacoustic transducer of the ultrasonic sensor via an excitation pulse to carry out mechanical oscillations, whereby a measuring signal is transmitted by the transducer;
receiving an echo signal the transducer; and
ascertaining a piece of object information from the echo signal;
wherein a frequency profile of the excitation pulse being different in two measuring cycles which are carried out chronologically consecutively;
wherein the frequency profile of the excitation pulse is selected in each measuring cycle randomly or according to a predefined sequence from a group of predefined frequency profiles.

27. The distance measuring device, comprising:
a plurality of ultrasonic sensors, the ultrasonic sensors being situated in a line at a chassis part of a motor vehicle, each of the ultrasonic sensors being operated by:
consecutively carrying out a plurality of measuring cycles, in each of the measuring cycles:
exciting the consecutively carrying out a plurality of measuring cycles, in each of the measuring cycles:
exciting an electroacoustic transducer of the ultrasonic sensor via an excitation pulse to carry out mechanical oscillations, whereby a measuring signal is transmitted by the transducer;
receiving an echo signal the transducer; and
ascertaining a piece of object information from the echo signal;
wherein a frequency profile of the excitation pulse being different in two measuring cycles which are carried out chronologically consecutively;
wherein the frequency profile of the excitation pulse is selected in each measuring cycle randomly or according to a predefined sequence from a group of predefined frequency profile;
wherein the ultrasonic sensors are operated in such a way that the ultrasonic sensors which are situated adjacent to one another do not have chronologically overlapping measuring cycles.
